(19) United States
(12) Patent Application Publication
(10) Pub. No.: US 2009/0022275 A1
(43) Pub. Date: Jan. 22, 2009

(54) Medical examination or intervention device

(76) Inventors: Albert Grebner, Eckental (DE); Judith Regn, Nurnberg (DE); Stefan Sattler, Forchheim (DE); Manfred Schonborn, Gerhardshofen (DE); Reiner Staab, (US); Susanne Staab, Baierdorf (DE); Katharina Staab, Aschaffenburg (DE); Silvia Rachor, Golbach (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/009,312

(22) Filed: Jan. 17, 2008

(30) Foreign Application Priority Data
Jan. 17, 2007 (DE) 10 2007 002 401.2

(51) Int. Cl. H05G 1/10; H05G 1/02

(52) U.S. Cl. 378/95; 378/196; 378/198

(57) ABSTRACT

A medical examination or intervention device that includes at least one component, in particular a C-arm, that can be moved under a user's control via a manual control device, as well as a collision monitoring device embodied for ascertaining an imminent collision and/or one having already occurred, with the control device having a haptic indicating means, controlled by the collision monitoring device, for indicating an imminent component collision and/or one having already occurred.

### CROSS REFERENCE TO RELATED APPLICATIONS

This application claims priority of German application No. 10 2007 002 401.2 filed Jan. 17, 2007, which is incorporated by reference herein in its entirety.

### FIELD OF THE INVENTION

The invention relates to a medical examination or intervention device that includes at least one user-controlled component, particularly a C-arm, that can be moved via a manual control device, and to a collision monitoring device embodied for ascertaining an imminent collision and/or one having already occurred. It relates further to a method for manually controlling a device of said type.

### BACKGROUND OF THE INVENTION

Medical examination or intervention devices of said kind are widely known. In particular C-arm systems, for instance X-ray devices and suchlike, can here be cited as examples. Said devices are of increasingly flexible design, meaning that the degrees of freedom of movement of the movable components are increasing. Movable components of a C-arm system can be, for example, the C-arm itself or the patient table.

The collision potential is greater owing to said increased flexibility. Collisions can occur, for example, between the C-arm and the spatial confines or floor, an X-ray device's tube or detector can collide with the patient table or patient, and the patient table can collide with the C-arm etc.

To counter said risks of collision, collision monitoring devices have been proposed that are embodied for ascertaining an imminent collision and/or one having already occurred. These can be, for example, integrated in a general control unit of the examination or intervention device. While a user is moving a movable component into a collision situation via a manual control device, that fact will be established by the collision monitoring device and the user will receive an acoustic or visual warning. It is at the same time also known how to reduce the relevant component's traveling speed. It is, though, very usual with today's devices for the user to be able despite said warnings to maintain the component on a collision course because a medical necessity may be present.

Displays on a monitor, for example, are known in C-arm systems. The current collision situation is displayed thereon. A report, for example, can be output to a user, but it is further known how as additional information to display movement directions in which no further movement is possible. The user must, though, in any event read details from a monitor or interpret acoustic warning signals, consider that information, then decide how to steer out of the collision situation.

The multiplicity of warning sounds and textual or graphical details on monitors in the case of a medical examination or intervention device makes it difficult for a user to tell whether a new message or new warning signal has been issued and information concerning a collision has been output on a monitor. Collisions can then still occur despite the warning, and protection devices and the whole process will be rendered highly complex for a user.

### SUMMARY OF THE INVENTION

The object of the invention is therefore to make it easier for a user to manually operate a movable component of a medical examination or intervention device, in particular if a collision is imminent or has already occurred.

To achieve said object it is inventively provided a device comprising at least one user-controlled component, particularly a C-arm, that can be moved via a manual control device. The control device has a haptic indicating means controlled by a collision monitoring device for indicating an imminent component collision and/or one having already occurred.

Information about a collision that has occurred and/or is imminent can in that way be conveyed to a user directly via the control element, for example a joystick, which he/she is touching to move the component. Because the control element is linked directly to the components' movability an intuitive solution is provided thereby, meaning that a user will be able to associate the warning signal directly. Tactile feedback realized in that way will be perceived by the user advantageously in every case, in contrast to acoustic feedback, which may be too quiet, or to visual feedback, for which the user needs to observe a monitor. Thanks to the present invention the device user will hence be able to keep looking at the component or patient while the component is being positioned because a warning of a collision or, as the case may be, imminent collision can be given directly via the control element being held or touched by the user.

In a further advantageous embodiment the collision monitoring device can be embodied for ascertaining a collision hazard value dependent on a distance that will be covered up to a collision, and the indicating means can be embodied for haptically indicating said collision hazard value. For example it can be provided for the manual control element to vibrate increasing strongly as the risk of collision increases so that, as it were, the intensity of warning information can be embodied as increasing. The user will accordingly obtain the information about how close he/she is to an actual collision solely through his/her contact with the control element.

In a particularly expedient embodiment variant the collision hazard value can be embodied as ascertainable as a function of direction and the indicating means can be embodied for indicating said collision hazard value as a function of direction. In addition to the height of the risk of collision it will in that case accordingly also be indicated in which direction there is a risk of collision. It can for that purpose in particular be provided for the indicating means to be embodied for indicating the collision hazard value in a particular direction when the control device is actuated for moving the component in said direction. The user will in that way ultimately obtain all information relevant for him/her and an intuitively understandable operating concept which, also depending on his/her desired movement direction, can give him/her information on how great a risk of a collision in said direction actually is. If, say, a collision is imminent and the control element is operated to produce a movement in the direction posing the risk of collision, then a correspondingly strong warning signal will be issued so that the user will intuitively stop producing the movement in said direction and can start producing a movement in a direction in which there is no risk of collision. Through the collision hazard value's being indicated haptically, as a function of direction, what is accordingly conveyed is not only the information on how close the ultimate collision is but also the direction of the impending risk.

The indicating means can include, for example, a vibration device and/or force generator. A vibration device has the advantage of being a widely known state-of-the-art technology employed extensively in, for example, cell phones. If one or more force generators are used, then the result in conjunction with indicating the collision hazard value as a function of direction will be a particularly advantageous embodiment if the force generator is embodied for producing a counterforce acting against operating in a particular direction as a function of the collision hazard value. Information will accordingly be conveyed particularly intuitively to the user through increasing resistance in the direction of a risk of collision. Too great an excursion, for example, will furthermore be prevented so that, given suitably embodied devices, a slower movement within the collision region can already be achieved in that way. A user will intuitively employ chiefly the degrees of freedom of movement within which he/she experiences no counterforce. Because the counterforce acts only against the collision direction, the user can via the control device simply sense in which direction no counterforce is acting and it will thereby be stipulated to him/her in which direction or directions he/she needs to steer to avoid the collision. It will no longer be necessary to absorb and process visually displayed information. The counterforce curve can in particular be such that the control device will not be operable in a direction in which a collision is imminent, meaning that movement will be blocked directionally selectively. A collision will thus also be avoided thereby.

While a motor, for example, can generally be employed as the force generator, the use of, for instance, pneumatic or hydraulic force generators is certainly also possible. A counterforce or reluctant response can furthermore be produced by means of devices that operate using friction.

The control device can be, for example, a joystick, although any other types of control devices are also conceivable, for example a key panel on which the keys' smooth or, as the case may be, reluctant response can be set or individual keys can vibrate.

To increase safety in collision monitoring it can be provided for at least one further acoustic and/or visual indicating means for indicating an imminent component collision and/or one having already occurred to be furnished. That means the hitherto known indicating options can also continue being used as a support so that the user can be comprehensively informed.

The indicating means can expediently be embodied for haptically indicating at least one further operating variable, in particular a further risk situation. For example the ideal positioning for medical inquiries can be indicated for image recording. Another possibility is for certain device components requiring to be deactivated before the component is moved, for example locking devices and suchlike, to be indicated.

Collision monitoring devices as employed in the present invention are basically known from the prior art and will not be discussed in more detail here.

The invention relates also to a method for manually controlling a medical examination or intervention device having at least one component that can be moved under a user's control via a control device, and a collision monitoring device, with the collision monitoring device ascertaining an imminent collision and/or one having already occurred and controlling a haptic indicating means, integrated in the control device, for indicating the imminent collision and/or one having already occurred. The method can in particular be used with the inventive medical examination or intervention device. Intuitive and simple user feedback in collision situations is possible with said method, also. Everything that has been said regarding the device can incidentally be applied to the inventive method.

The collision monitoring device can in particular convey a collision hazard value dependent on a distance that will be covered up to a collision and control the indicating means for haptically indicating the collision hazard value. The collision hazard value can additionally be ascertained as a function of direction and indicated via the indicating means as a function of direction. As a possibility for implementing said embodiment the indicating means can, for example, indicate the collision hazard value in a particular direction when the control device is actuated for moving the component in said direction. All necessary information, namely that a collision is imminent, how great the hazard is, and in which direction a collision is to be feared, will in that way be indicated to the user.

It can also be expediently provided in the method for the control device to be blocked for operation in a direction in which a collision is imminent. A collision will then be avoided.

In addition to being indicated haptically, the imminent collision and/or one having already occurred can also be indicated acoustically and/or visually with the inventive method.

It is also possible in a further embodiment for at least one further operating variable, in particular a risk situation, to be indicated via the indicating means.

### BRIEF DESCRIPTION OF THE DRAWINGS

Further advantages and specifics of the present invention will emerge from the exemplary embodiment described below and with reference to the drawings, in which:

FIG. 1 shows a medical examination device embodied as an X-ray device, and

FIG. 2 shows an embodiment of a manual control element for a movable component in the X-ray device.

### DETAILED DESCRIPTION OF THE INVENTION

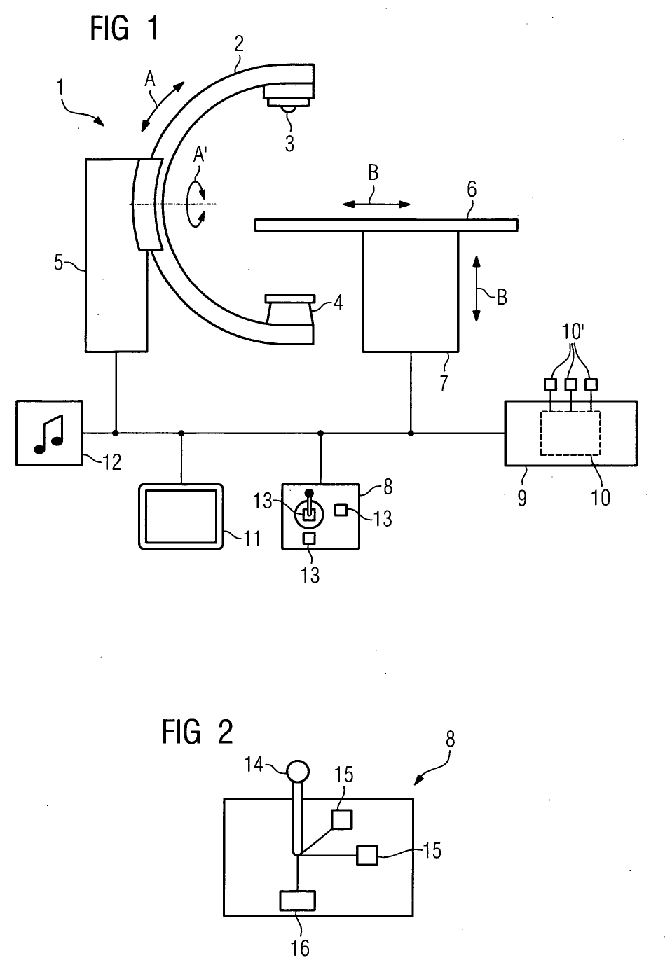

FIG. 1 shows an X-ray device 1. It is what is termed a C-arm system having a C-arm 2 on which arranged opposite one another are a radiation source 3 and a radiation detector 4. The C-arm 2 can be moved or swiveled in different directions, see arrows A, via a corresponding bearing 5. The X-ray device 1 additionally includes a patient table 6 arranged likewise movably on the base 7, as is indicated by the arrows B. A manual control device 8 is provided for controlling the movable components, which is to say the C-arm 2 and the patient table 6. The X-ray device 1 further includes a controlling device 9 that also includes the control unit of a collision monitoring system indicated at 10. Sensors 10′ or other detection means also belong to the collision monitoring system in a manner known per se. The collision monitoring system 10 ultimately determines the locations of the movable and fixed components of the X-ray device 1 as well as ascertaining other obstacles with which a collision can occur, in particular also a patient lying on the patient table 6. From the established locations it is possible to determine a distance that will be covered up to a collision and, from said distance, a collision hazard value. Said collision hazard value can of course be ascertained by the collision monitoring device 10 also as a function of a possible movement direction, meaning in a direction-dependent manner.

The X-ray device 1 further includes a visual indicating means 11 and an acoustic indicating means 12 for visually and acoustically forwarding information to a user.

The manual control device 8, here embodied as a joystick, inventively additionally includes haptic indicating means 13 that can be controlled by the controlling device 9 and in particular also by the collision monitoring system 10.

FIG. 2 is a schematic sketch of the manual control device 8. It is embodied as a joystick 14 that can be moved in two mutually orthogonal directions. Two force generators 15, in this case motors, and a vibration device 16 are provided as haptic indicating means 13. The force generators 15 are embodied for producing a counterforce in specific operating directions as a function of a signal conveyed by the controlling device 9. The force generators 15 can in particular also be controlled in such a way as to render operating in a particular direction totally impossible. It is to be noted at this point that while only two force generators 15 are shown by way of example, a greater number thereof can of course also be provided. Also, the vibration device 16 can be absent in other embodiment variants, although it is possible also to provide just one or a plurality of vibration devices 16 and then no force generators 15.

The collision monitoring device 10 then continuously determines the distance that will be covered up to a collision and, from said distance, a collision hazard value that is established as a function of direction for each of the movable components. The haptic indicating means 13, which is to say the force generators 15 and vibration device 16, can in a collision situation—meaning if a threshold for the collision hazard value has been exceeded in at least one direction—then be controlled accordingly by means of said direction-dependent collision hazard value. The collision monitoring device 10 in particular controls the force generators 15 in such a way that a counterforce will be produced that increases as the risk of collision increases and which, in the event of an imminent collision, will no longer allow the control device 8 to be operated in the relevant direction. A warning can additionally be given by means of the vibration device 16. A more intuitive operating concept that is easier to apply will have been implemented thereby.

In addition to haptic indicating it is of course also possible to use the visual indicating means 11 and/or acoustic indicating means 12 for indicating an imminent component collision or one having already occurred. Additional information can be conveyed thereby.

Within the scope of the invention the haptic indicating means can be embodied also for haptically indicating further information, for example operating variables or further risk situations. For example an ideal positioning for image recording can be indicated or the fact that certain locks have yet to be released.

1.-17. (canceled)

18. A medical device, comprising:
a movable component;
a control device that moves the component;
a collision monitoring device that ascertains a collision; and
an indicating device arranged in the control device that is controlled by the collision monitoring device and indicates the collision.

19. The device as claimed in claim 18, wherein the indicating device comprises a vibration device.

20. The device as claimed in claim 18, wherein the collision monitoring device ascertains a collision hazard value depending on a distance that is covered up to the collision and the collision hazard value is haptically indicated by the indicating device.

21. The device as claimed in claim 20, wherein the collision hazard value is ascertained as a function of direction and the indicating device indicates the collision hazard value as a function of direction.

22. The device as claimed in claim 21, wherein the indicating device indicates the collision hazard value in a direction when the control device is actuated for moving the component in the direction.

23. The device as claimed in claim 22, wherein the indicating device comprises a force generator that generates a counterforce acting against moving the component in the direction as a function of the collision hazard value.

24. The device as claimed in claim 23, wherein the control device cannot be operated in the direction when the collision is going to occur in the direction.

25. The device as claimed in claim 18, wherein the control device is a joystick.

26. The device as claimed in claim 18, further comprising an acoustic indicating device or a visual indicating device that indicates the collision.

27. The device as claimed in claim 18, wherein the indicating device haptically indicates an operating variable.

28. The device as claimed in claim 27, wherein the operating variable is a further risk situation.

29. The device as claimed in claim 18, wherein the component is a C-arm.

30. The device as claimed in claim 18, wherein the collision is an imminent collision or a collision that has already occurred.

31. The device as claimed in claim 18, wherein the collision is between components selected from the group consisting of: a C-arm, a spatial confine, a floor, a tube of an x-ray device, a detector of an x-ray device, a patient table, and a patient.

32. The device as claimed in claim 18, wherein the indicating device is a haptic indicating device.

33. The device as claimed in claim 18, wherein the control device moves the component under a user's control.

34. The device as claimed in claim 18, wherein the medical device is a medical examination device or an intervention device.

35. A method for controlling a medical device, comprising:
moving a component of the medical device via a control device;
ascertaining a collision by a collision monitoring device;
indicating the collision by an indicating device arranged in the control device and controlled by the collision monitoring device; and
controlling the medical device according to the indication.
